(19) United States
(12) Patent Application Publication
(10) Pub. No.: US 2012/0325375 A1
(43) Pub. Date: Dec. 27, 2012

(54) Steel Sheet Manufactured by Decarburizing Solid Sponge Iron and Method for Manufacturing the Same

(75) Inventors: Yasushi SASAKI, Pohang-Si (KR); Ji-Ook PARK, Busan (KR)

(73) Assignee: POSTECH ACADEMY-INDUSTRY FOUNDATION, Pohang-city (KR)

(21) Appl. No.: 13/455,362

(22) Filed: Apr. 25, 2012

(30) Foreign Application Priority Data
Jun. 21, 2011 (KR) 10-2011-0060312

(51) Int. Cl. C23C 8/10; B32B 15/04; B22D 25/06

(52) U.S. Cl. 148/278; 148/400

(57) ABSTRACT

A steel sheet which is decarburized after being strip casted and a method for manufacturing the same are provided. A method for manufacturing the steel sheet includes i) providing molten iron, ii) removing sulfur, phosphorus, and silicon from the molten iron, iii) strip casting the molten iron and providing the steel sheet, and iv) heating and contacting the steel sheet with an oxidization gas while decarburizing the steel sheet.

### CROSS-REFERENCE TO RELATED APPLICATION

This application claims priority to and the benefit of Korean Patent Application No. 10-2011-0060312 filed in the Korean Intellectual Property Office on Jun. 21, 2011, the entire contents of which are incorporated herein by reference.

### BACKGROUND OF THE INVENTION

(a) Field of the Invention

The present invention relates to a steel sheet and a method for manufacturing the same. More specifically, the present invention relates to a steel sheet which is manufactured by effectively decarburizing strip-casted high carbon solid sponge iron and a method for manufacturing the same.

(b) Description of the Related Art

Molten iron produced from a blast furnace contains a lot of carbon. Therefore, it is necessary to remove carbon from the molten iron by injecting oxygen into the molten iron. Cast iron, which is made by directly solidifying molten iron without removing carbon, is brittle, and thereby it cannot be used for general purposes. Therefore, carbon is removed from the molten iron by generating carbon monoxide while injecting oxygen into the molten iron and reacting the oxygen with the carbon.

Meanwhile, metal with a good oxygen affinity such as aluminum, silicon, and titanium is used in order to remove the oxygen which is injected for decarburization. These metals form an oxide with oxygen, and thereby oxygen in the molten iron can be removed. However, since these oxides cannot be completely removed from the steel plate which is made by solidifying the molten iron, they partly remain as inclusions as they are. These inclusions negatively affect properties of the steel plate.

### SUMMARY OF THE INVENTION

A steel sheet, which is manufactured by removing carbon from molten iron without injecting oxygen thereinto, is provided. In addition, a method for manufacturing the above steel sheet is provided.

A method for manufacturing a steel sheet according to an embodiment of the present includes i) providing molten iron, ii) removing sulfur, phosphorus, and silicon contained in the molten iron, iii) strip casting the molten iron and providing the steel sheet, and iv) heating and contacting the steel sheet with an oxidization gas while decarburizing the steel sheet.

The oxidization gas may include H₂O or CO₂ in the decarburizing of the steel sheet. The steel sheet may be heated at a temperature of a range from 800° C. to 1100° C. to be decarburized. The decarburizing of the steel sheet may include i) firstly decarburizing the steel sheet at a temperature not more than 910° C.; and ii) secondly decarburizing the firstly decarburized steel sheet at a temperature of less than 910° C. A ratio of a partial pressure of hydrogen to a sum of partial pressures of hydrogen and steam may be not less than 0.7 when the oxidization gas includes hydrogen and steam.

The molten iron may include carbon at 2 to 6 wt %, oxygen at not more than 30 ppm, Fe, and impurities in the providing of the steel sheet. A temperature of the molten iron may be in a range from 1200° C. to 1600° C. in the providing of the steel sheet. A thickness of the steel sheet may be in a range from 0.5 mm to 3 mm in the providing of the steel sheet.

A steel sheet according an embodiment of the present invention is manufactured by the above method. The steel sheet includes i) a plurality of surface layers that are spaced apart from each other, and ii) a center layer that is located between the plurality of surface layers. A carbon concentration of the center layer is greater than a carbon concentration of the surface layers, and the content of the carbon in the center layer is less than 0.1 wt %.

A ratio of a thickness of the surface layer to a thickness of the center layer may not be more than 0.9. The thickness of the steel sheet may be in a range of 0.5 mm to 3 mm.

Inclusions such as oxides contained in the steel sheet can be easily removed by using the solid iron making process without injecting oxygen. Properties of the steel sheet can be largely improved since the contents of oxygen contained in the steel sheet can be disregarded. In addition, since the steel sheet can be directly manufactured by using a strip casting process, processes such as reheating and hot rolling can be omitted during manufacture of the steel sheet, and thereby processing time and cost can be reduced. In addition, the amount of generated carbon dioxide in the iron making process can be reduced.

### BRIEF DESCRIPTION OF THE DRAWINGS

FIG. 1 is a flow chart schematically showing a method for manufacturing a steel sheet according to an embodiment of the present invention.

FIG. 2 is a phase diagram of a Fe—C—O alloy showing a method for manufacturing the steel sheet of FIG. 1.

FIG. 3 is a phase diagram of a Fe—C—O alloy showing a method for manufacturing a steel sheet according to a conventional method.

FIG. 4 schematically shows an apparatus for manufacturing a steel sheet for performing a method for manufacturing the steel sheet of FIG. 1.

FIG. 5 schematically shows a cross-section of the steel sheet manufactured according to the method for manufacturing the steel sheet of FIG. 1.

FIG. 6 is a graph showing a variation of the decarburization depth of the steel sheet according to exemplary examples of the present invention.

FIG. 7 is a graph showing a variation of carbon content of the steel sheet according to exemplary examples of the present invention.

### DETAILED DESCRIPTION OF THE EMBODIMENTS

The technical terms used herein are to simply mention a particular exemplary embodiment and are not meant to limit the present invention. The technical terms used herein are to simply mention a particular exemplary embodiment and are not meant to limit the present invention. An expression used in the singular encompasses the expression of the plural, unless it has a clearly different meaning in the context. In the present invention, it is to be understood that the terms such as “including,” “having,” etc., are intended to indicate the existence of the specific features, regions, numbers, stages, operations, elements, components, or combinations thereof disclosed in the specification, and are not intended to preclude the possibility that one or more other specific features, regions, numbers, operations, elements, components, or combinations thereof may exist or may be added.

Unless otherwise defined, all terms used herein, including technical or scientific terms, have the same meanings as those generally understood by those with ordinary knowledge in the field of the art to which the present invention belongs. Such terms as those defined in a generally used dictionary are to be interpreted to have the same meanings as the contextual meanings in the relevant field of art, and are not to be interpreted to have idealized or excessively formal meanings unless clearly defined in the present application.

The exemplary embodiments of the present invention described with reference to perspective views and sectional views substantially represent the ideal exemplary embodiments of the present invention. As those skilled in the art would realize, the described embodiments may be modified in various different ways, all without departing from the spirit or scope of the present invention.

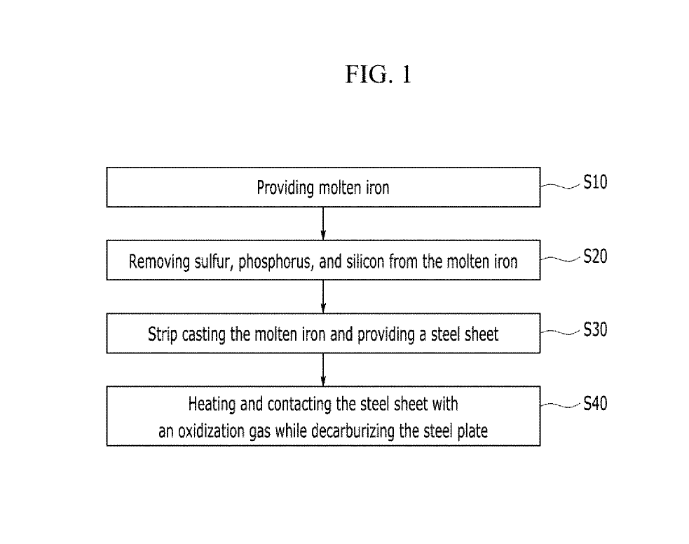

FIG. 1 schematically shows a flowchart of a method for manufacturing the steel sheet according to an embodiment of the present invention. The method for manufacturing the steel sheet of FIG. 1 is merely to exemplify the present invention and the present invention is not limited thereto. Therefore, a method for manufacturing a steel sheet can be performed in other ways.

As shown in FIG. 1, the method for manufacturing the steel sheet includes providing molten iron (S10), removing sulfur, phosphorus, and silicon contained from the molten iron (S20), providing the steel sheet by strip casting the molten iron (S30), and decarburizing the steel sheet by heating and contacting the steel sheet with an oxidization gas (S40). The method for manufacturing the steel sheet may further include other steps as necessary.

First, the molten iron is provided in the step S10. That is, coke and sintered ore are charged into the blast furnace while hot air is injected thereinto, and thereby sintered ore is reduced and melted by carbon and molten iron is manufactured. However, the method for manufacturing molten iron is not merely limited to the blast furnace, and other methods for manufacturing molten iron such as a smelting reduction iron making process or using an electric arc furnace (EAF) can also provide the molten iron. The molten iron is discharged outside from a tap located at a lower portion of the blast furnace. The discharged molten iron contains carbon since it was formed to be reacted with coke.

In the step S20, sulfur, phosphorus, and silicon are removed from the molten iron. The amount of silicon is minimized before the phosphorus is removed in order to effectively remove the phosphorus by using limestone contained in the molten iron. For example, the content of the phosphorus can be controlled to be less than 50 ppm. Meanwhile, decarburization and deoxidization processes of the molten iron are not performed in step S20. Finally, the steel sheet is brittle while manufacturing the steel sheet if contents of the sulfur, phosphorus, and silicon contained in the steel sheet are great. Therefore, sulfur, phosphorus, and silicon are removed in step S20, and thereby the steel sheet is not brittle. A process of removing sulfur, phosphorus, and silicon from the molten iron can be easily understood by those skilled in the art, thereby a detailed description thereof is omitted.

Next, a steel sheet is provided by strip casting the molten iron in step S30. Here, the temperature of the molten iron can be in a range from 1200° C. to 1600° C. If the temperature of the molten iron is too low, it is not suitable to be strip casted since the molten iron can quickly solidify. In addition, if the temperature of the molten iron is too high, apparatuses used in transporting molten iron can be deteriorated. Therefore, the temperature of the molten iron is controlled within the above range.

The molten iron is casted as a thin steel strip while being solidified by being strip casted. The molten iron used in the strip casting contains carbon in a range from 2 wt % to 6 wt %, oxygen at not more than 30 ppm, Fe, and impurities. It is difficult to control the content of the carbon contained in the molten iron be less than 2 wt % while manufacturing of the molten iron due to the contents of the coke charged into the blast furnace. In addition, if the content of the carbon contained in the molten iron is greater than 6 wt %, it is not desirable in an aspect of thermal efficiency since a large amount of coke should be used. Therefore, the content of the carbon contained in the molten iron is controlled in the above range. In addition, if the content of the oxygen contained in the molten iron is greater than 30 ppm, a large amount of metals with good affinity to oxygen should be used in order to remove the oxygen from the molten iron. Therefore, it is desirable to control the amount of oxygen contained in the molten iron to be not more than 30 ppm in order to not generate a large amount of inclusions which can badly affect the properties of the steel sheet.

The molten iron is charged into a tundish after being transported by using a ladle, and the tundish transports molten iron to an apparatus for strip casting in step S30. Therefore, the molten iron is transported in the apparatus for strip casting while being solidified, thereby being manufactured into a thin steel sheet. Here, the thickness of the steel sheet may be in a range of 0.5 mm to 3 mm. If the thickness of the steel sheet is less than 0.5 mm, its industrial applicability is deteriorated since the steel sheet is too thin. In addition, if the thickness of the steel sheet is greater than 3 mm, time and cost for decarburization of the steel sheet become great in the following step. Therefore, the thickness of the steel sheet is controlled in the above range.

Meanwhile, in comparison with a slab manufacturing process with a line length of 500 m to 800 m, more specifically 300 m to 400 m, the strip casting process is very effective in an aspect of manufacturing process since its line length is merely about 60 m. In addition, the total line length is not so great even if a decarburization process is added to the strip casting process. Furthermore, the strip casting process itself prevents the inclusions from being coarsely aggregated, and thereby the copper contained in the steel sheet does not badly affect the steel sheet.

Finally, the steel sheet is heated and contacted with the oxidization gas while being decarburized in step S40. That is, carbon contained in the steel sheet is removed by reacting the steel sheet as a solid with an oxidization gas in a solid iron making process in step S40. For example, carbon can be removed by using a bright annealing method. In contrast with other processes, carbon contained in the steel sheet can be easily removed by reacting the oxidization gas with the steel sheet since the steel sheet manufactured by using the strip casting process is very thin. For this, the steel sheet is heated in a range from 800° C. to 1100° C. while being decarburized. If the heating temperature of the steel sheet is less than 800° C., the steel sheet and the oxidization gas cannot react with each other well. In addition, if the heating temperature of the steel sheet is greater than 1100° C., it is possible that it may liquefy as the content of the carbon contained in the steel sheet becomes less than 2.11 wt %. Therefore, the heating temperature of the steel sheet is controlled in the above range. The steel sheet is easily heated to react with the injected oxidization gas by charging the steel sheet into the decarburization furnace and then heating it.

The oxidization gas can contain H₂O, CO₂, and so on. As described in Chemical Formula I, H₂O or CO₂ reacts with carbon contained in the steel sheet and then generates a gas such as CO₂, H₂, or CO, thereby removing carbon from the steel sheet.

2H₂O+C→CO₂+2H₂

CO₂+C→2CO Chemical Formula 1

As described above, the steel sheet, which has gone through the strip casting in step S30, is directly decarburized in step S40, and thereby carbon contained in the steel sheet can be easily removed at once without using other processes. For example, the steel sheet containing C at 3.89 wt % with a thickness of 1 mm is decarburized at 1100° C. using H₂O/H₂ gas as an oxidization gas, and thereby the steel sheet can be totally transformed into an austenitic phase. In this case, the process can be completed in just less than 20 minutes. As described above, since the steel sheet can be continuously manufactured through the continuous molten iron tapping, strip casting, and decarburization process, manufacturing cost and time of the steel sheet can be largely reduced.

Conventionally, multiple steps of the steel making process such as injection of oxygen into the molten iron for decarburizing the molten iron after manufacturing and charging of metals with a good affinity with oxygen into the molten iron for removing the oxygen are necessary. As a result, the manufacturing process was very complex and manufacturing processes and time were increased. Furthermore, inclusions remained in the manufactured steel sheet caused by the steel making process of multiple steps imparted a negative impact on quality of the steel sheet. However, according to an embodiment of the present invention, carbon is effectively removed from the steel sheet without mixing oxygen and other metals by continuously combining the strip casting process and the decarburization process. Therefore, the steel making process of multiple steps is not necessary a problem caused by the remaining inclusions in the steel plate can be prevented.

Meanwhile, the steel sheet can be decarburized by using other methods in step S40. That is, in step S40 of decarburizing the steel sheet, the steel sheet is firstly decarburized at a temperature of not less than 910° C. and then the firstly decarburized steel sheet can be secondly decarburized at a temperature of less than 910° C. That is, the content of carbon contained in the solid sponge iron is effectively reduced through the first decarburization process, and thereby an austenitic phase can be formed. In addition, a layered structure containing ferritic and austenitic phases is generated by forming a ferritic layer on a surface of the steel sheet through the second decarburization at a low temperature. Furthermore, the steel sheet with the layered structure is suitably cooled in a following process, and thereby the steel sheet can be manufactured with ferritic and martensitic layered structures with good ductility and strength.

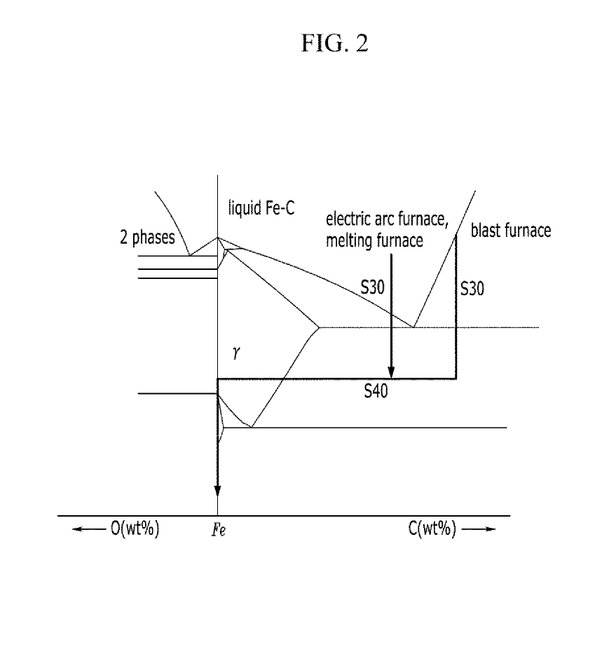

Meanwhile, a surface of the steel sheet can be oxidized by an oxidization gas when the steel sheet is decarburized. Therefore, partial pressure of the oxidization gas is controlled for preventing the above phenomenon. The partial pressure of the gas for preventing oxidization is varied to be dependent on a temperature and a composition of the decarburization gas. For example, if a ratio of partial pressure of the hydrogen to a sum of partial pressures of hydrogen and steam in a mixed gas of the hydrogen and steam containing argon gas at 50% is not less than 0.7, the steel sheet is not oxidized since the austenite is more stable than the wustite at a temperature range of not less than 800° C. The carbon is not removed well from the steel sheet if the partial pressure of the oxidization gas is too low. On the contrary, the steel sheet can be oxidized if the partial pressure of the oxidization gas is too high. Therefore, the partial pressure of the oxidization gas is controlled in the above range. A surface of the steel sheet can be made smooth through finishing rolling or surface grinding since a plurality of pores remain on the surface of the solid decarburized steel sheet. A method for manufacturing the steel sheet of FIG. 1 is explained in detail with reference to a phase diagram of a Fe—C—O alloy of FIG. 2 below.

FIG. 2 schematically shows a phase diagram of the Fe—C—O alloy related to the method for manufacturing of the steel sheet of FIG. 1. The method for manufacturing the steel sheet of FIG. 1 shown in the phase diagram of the Fe—C—O alloy of FIG. 2 is merely to illustrate the present invention and the present invention is not limited thereto. Therefore, FIG. 2 can have other forms.

As shown in FIG. 2, molten iron of liquid Fe—C is manufactured in a blast furnace, an electric arc furnace, or a melting furnace. That is, steps S10 and S20 of FIG. 1 are performed. The molten iron can be provided from the blast furnace, electric arc furnace, or melting furnace, and the furnace is not limited to a special one. Next, the solid steel sheet is manufactured by strip casting the molten iron in step S30 of FIG. 1. In addition, an amount of carbon contained in the steel sheet is reduced to about 0% by decarburizing the steel sheet and then the steel sheet is cooled to room temperature. A decarburized steel sheet can be manufactured in an order as shown in the phase diagram of FIG. 2.

As shown in FIG. 2, a process of injecting oxygen for decarburizing the steel sheet is not included. That is, the steel sheet with a desirable property can be manufactured by decarburizing the solid steel sheet.

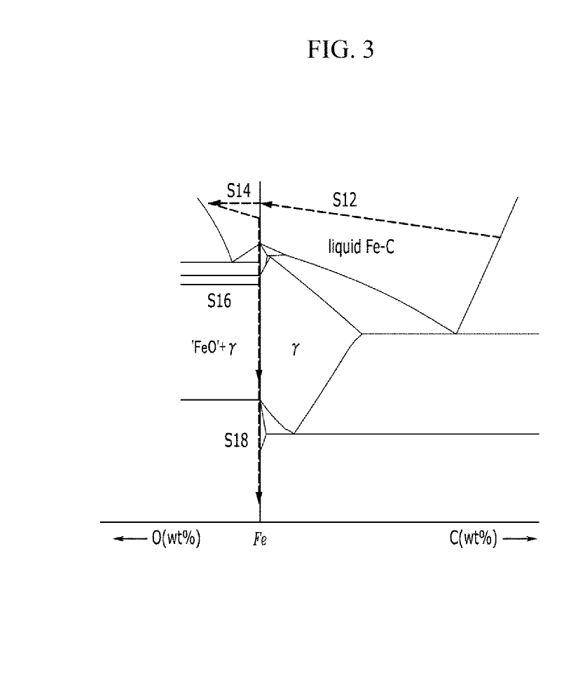

FIG. 3 schematically shows a phase diagram of the Fe—C—O alloy related to a method for manufacturing a steel sheet according to a conventional method. The method for manufacturing the steel sheet according to the conventional method of FIG. 3 is different from that according to an embodiment of the present invention of FIG. 2.

As indicated by an arrow in FIG. 3, since oxygen is injected into the molten iron in order to remove carbon therefrom, the amount of oxygen is increased while the amount of carbon is reduced in step S12. Since the oxygen is excessively injected in order to reduce the content of the carbon contained in the molten iron, the oxygen is added to the molten iron in step S14. Therefore, a metal with a good affinity with oxygen is charged into the molten iron in order to remove oxygen contained in the molten iron in step S16. As a result, content of oxygen contained in the molten iron is controlled to about 0 wt % in step S16 and the steel sheet is manufactured by cooling the molten iron in step S18. As described above, the method for manufacturing the steel sheet according to the conventional method includes processes of injecting oxygen and removing oxygen for decarburization. As a result, the process is not only complex but also the manufacturing cost is high.

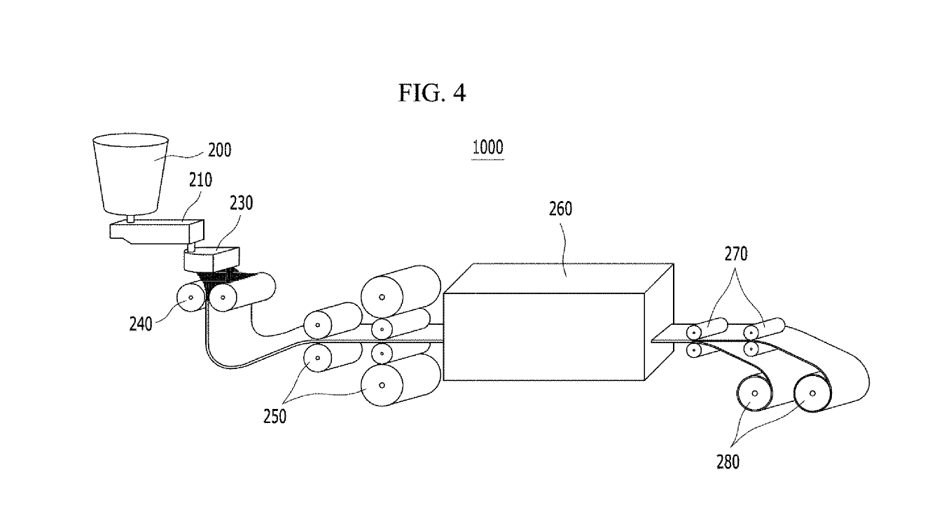

FIG. 4 schematically shows an apparatus for manufacturing a steel sheet 1000 in order to perform the method for manufacturing the steel sheet of FIG. 1. A structure of the apparatus for manufacturing a steel sheet 1000 of FIG. 4 is merely to illustrate the present invention and the present invention is not limited thereto. Therefore, the structure of the apparatus for manufacturing a steel sheet 1000 can have other forms.

As shown in FIG. 4, the apparatus for manufacturing a steel sheet 1000 includes a ladle 200, a tundish 210, a pathway direction converter 230, a pair of rolls 240, a mill roll 250, a decarburization furnace 260, a deflector roll 270, and a coiler 280. The apparatus for manufacturing a steel sheet 1000 may further include other elements if necessary.

Firstly, the molten iron having undergone step S20 of FIG. 1 is transferred to be stored in the ladle 200. The molten iron transported to the ladle 200 is injected into the tundish 210 and then the tundish 210 transports the molten iron to the pathway direction converter 230. The pathway direction converter 230 injects the molten iron into a gap between the pair of neighboring rolls 240. Since a gap is suitably formed between the pair of rolls 240, the molten iron is discharged through the gap and then the solidified steel sheet is manufactured. Since the size of the gap is not large, a pool of the molten iron is formed between the pair of rolls 240. Since the specific gravity of the molten iron is high, it is desirable to manufacture the steel sheet by discharging the molten iron toward a vertical direction by using the pair of rolls horizontally arranged side by side. The molten iron is solidified to the steel sheet while being discharged between the pair of rolls 240. Since the thickness of the steel sheet is not uniform, the steel sheet is made to have a uniform thickness by rolling the steel sheet using the rolling mill 250. As a result, a thin steel sheet with uniform thickness can be manufactured.

Next, the steel sheet is heated to a high temperature in the decarburization furnace while being decarburized by an oxidization gas. After the decarburized steel is transported by a deflector roll 270, the steel sheet is coiled using the coiler 280. As described above, since a series of processes combining the strip casting device with the decarburization furnace are performed at once, the steel sheet can be easily manufactured and the manufacturing cost can be largely reduced as well.

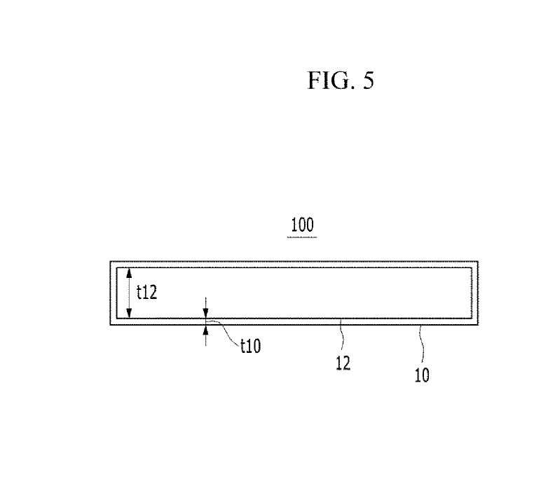

FIG. 5 schematically shows a sectional structure of the steel sheet 100 which is manufactured according to a method for manufacturing the steel sheet of FIG. 1. The sectional structure of the steel sheet 100 of FIG. 5 is merely to illustrate the present invention and the present invention is not limited thereto. Therefore, the sectional structure of the steel sheet 100 can have various forms.

As shown in FIG. 5, the steel sheet 100 contains surface layers 10 and a center layer 12. The surface layers 10 are spaced apart from each other, and the center layer 12 is located between the surface layers 10. The steel sheet 100 can further include other layers if necessary.

Here, the center layer 12 and the surface layer 10 can be divided from each other according to the content of carbon. A concentration of carbon in the center layer 12 is more than that in the surface layer 10. Since the oxidization gas acts on the center layer 12 after passing through the surface layer 10, concentration of the carbon of the surface layer 10 is less than that of the center layer 12. Here, the surface layer 10 is formed of an αFe phase while the center layer 12 can have a martensitic structure. As shown in FIG. 5, since the steel sheet 100 has a heterostructure, its mechanical properties depend on a thickness and a microstructure of each layer.

Here, a ratio of a thickness t10 of the surface layer 10 to a thickness t12 of the center layer 12 is not more than 0.9. If the ratio of the thickness t10 of the surfaced layer 10 is not less than 0.9, a time for decarburizing the steel sheet 100 is too long and it is not desirable for efficiency of a manufacturing process. Therefore, the ratio of the thickness t10 of the surface layer 10 to the thickness t12 of the center layer 12 is controlled as above. Meanwhile, the thickness t10 of the surface layered 10 can be further increased as a time of the oxidization gas contact with the steel sheet 100 becomes longer.

### EXEMPLARY EXAMPLES

The present invention is explained in detail below with reference to the exemplary examples. The exemplary examples are not merely to illustrate the present invention and the present invention is not limited thereto.

The steel sheet was decarburized by using a horizontal resistance furnace after the steel sheet with a thickness of 1 mm is manufactured by using centrifugal casting. Since the centrifugal casting had a high cooling speed, the cooling speed of the strip casting was similar to that of the centrifugal casting. Therefore, a microstructure of the steel sheet manufactured by the centrifugal casting was similar to that of the steel sheet manufactured by the strip casting and then experimental comparison is possible. A gas mixture of hydrogen and steam containing Ar at 50% as a decarburization gas with a ratio of the partial pressure of hydrogen to a sum of partial pressures of hydrogen and oxygen (P_{H2}/(P_{H2}+P_{H2O})) fixed at 0.78 was used. When the decarburization was performed under the above gas composition, the steel sheet was not thermodynamically oxidized. The steel sheet was decarburized for 5 minutes, 10 minutes, 15 minutes, 30 minutes, 60 minutes, and 120 minutes, respectively, and the steel sheet was water-cooled after the decarburization process was finished.

### Exemplary Example 1

The content of carbon contained in the steel sheet was 3.89 wt % and the decarburization process was performed at 975° C. The rest of the processes were the same as described above.

### Exemplary Example 2

The content of carbon contained in the steel sheet was 3.89 wt % and the decarburization process was performed at 1100° C. The rest of the processes were the same as in the above-described Exemplary Example 1.

### Exemplary Example 3

The content of carbon contained in the steel sheet was 4.35 wt % and the decarburization process was performed at 975° C. The rest of the processes were the same as in the above-described Exemplary Example 1.

### Exemplary Example 4

The content of carbon contained in the steel sheet was 4.35 wt % and the decarburization process was performed at 1100° C. The rest of the processes were the same as the above-described Exemplary Example 1.

### Results of the Exemplary Examples

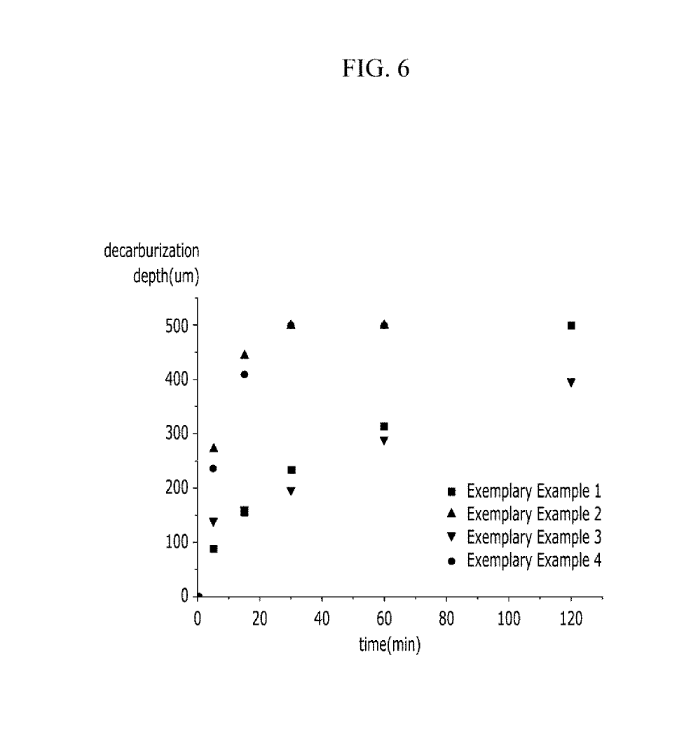

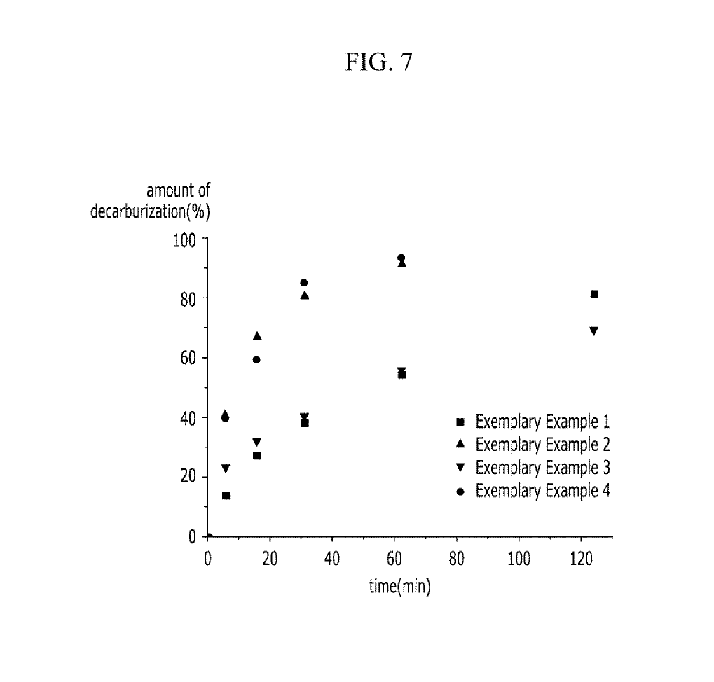

CS analysis was performed to the steel sheet manufactured by the above-described Exemplary Examples 1 to 4. The decarburization depth of the steel sheet was measured by using an electron microscope, and content of the carbon contained in the steel sheet was measured through CS analysis. The above results are shown in FIGS. 6 and 7, respectively.

FIG. 6 shows a graph regarding variation of decarburization depth of the steel sheet according to the exemplary examples of the present invention.

As shown in FIG. 6, the decarburization depths of the steel sheet treated with a relatively high decarburization temperature in Exemplary Examples 2 and 4 were shown to be greater than those treated with a relatively low decarburization temperature in Exemplary Examples 1 and 3. Therefore, decarburization of the steel sheet was shown to be more quickly advanced as the decarburization temperature became longer.

FIG. 7 shows a graph regarding variation of a content of carbon in the steel sheet according to the exemplary examples of the present invention.

As shown in FIG. 7, since the steel sheets with relatively low contents of carbon in Experimental Examples 1 and 2 have a hypoeutectic composition as opposed to the steel sheets with relatively high contents of carbon in Experimental Examples 3 and 4, they showed a fast decarburization speed. For example, a time for decarburizing the steel sheet with a hypoeutectic composition and transforming it into an austenitic phase was less than 20 minutes, and about 70% of the carbon contained in the steel sheet was removed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for manufacturing a steel sheet, comprising:
providing molten iron;
removing sulfur, phosphorus, and silicon contained in the molten iron;
strip casting the molten iron and providing the steel sheet; and
heating and contacting the steel sheet with an oxidization gas while decarburizing the steel sheet.

2. The method of claim 1, wherein the oxidization gas comprises H₂O or CO₂ in the decarburizing of the steel sheet.

3. The method of claim 2, wherein the steel sheet is heated at a temperature of a range from 800° C. to 1100° C. to be decarburized.

4. The method of claim 2, wherein the decarburizing of the steel sheet comprises:
firstly decarburizing the steel sheet at a temperature of not more than 910° C.; and
secondly decarburizing the firstly decarburized steel sheet at a temperature of less than 910° C.

5. The method of claim 2, wherein a ratio of a partial pressure of hydrogen to a sum of partial pressures of hydrogen and steam is not less than 0.7 when the oxidization gas comprises hydrogen and steam.

6. The method of claim 1, wherein the molten iron comprises carbon at 2 to 6 wt %, oxygen at not more than 30 ppm, Fe, and impurities in the providing of the steel sheet.

7. The method of claim 1, wherein a temperature of the molten iron is in a range of 1200° C. to 1600° C. in the providing of the steel sheet.

8. The method of claim 1, wherein a thickness of the steel sheet is in a range of 0.5 mm to 3 mm in the providing of the steel sheet.

9. A steel sheet manufactured by the method of claim 1, the steel sheet comprising:
a plurality of surface layers that are spaced apart from each other; and
a center layer that is located between the plurality of surface layers, wherein
a carbon concentration of the center layer is greater than a carbon concentration of the surface layers, and the content of the carbon in the center layer is less than 0.1 wt %.

10. The steel sheet of claim 9, wherein a ratio of a thickness of the surface layer to a thickness of the center layer is not more than 0.9.

11. The steel sheet of claim 9, wherein the thickness of the steel sheet is in a range of 0.5 mm to 3 mm.
